(19) United States
(12) Patent Application Publication
(10) Pub. No.: US 2026/0365894 A1
(43) Pub. Date: Nov. 19, 2026

(54) ADHESIVE FILM WITH CLEAN REMOVAL AFTER AGING

(71) Applicant: 3M INNOVATIVE PROPERTIES COMPANY, St. Paul, MN (US)

(72) Inventors: Grant W. Fahnhorst, Minneapolis, MN (US); Peter M. Simone, Woodbury, MN (US); Temesgen Gedore, Lake Elmo, MN (US); Adam R. Wohl, Mahtomedi, MN (US); Beau Alexander Hommes, Hudson, WI (US); Denis Terzic, Arden Hills, MN (US); Michelle Ji, Woodbury, MN (US); Diane North, Inver Grove Heights, MN (US)

(21) Appl. No.: 19/141,124

(22) PCT Filed: Dec. 15, 2023
(86) PCT No.: PCT/IB2023/062822

§ 371 Date: Jun. 19, 2025

Related U.S. Application Data
(60) Provisional application No. 63/434,611, filed on Dec. 22, 2022.

(51) Int. Cl. C09J 139/06; C09J 133/10

(52) U.S. Cl. CPC C09J 139/06; C09J 133/10; C09J 2433/00

(57) ABSTRACT

A precursor composition for an adhesive usable in a film includes a (meth)acrylate copolymer is made by a copolymerization of a monomeric mixture. The monomeric mixture includes an acid functional polar monomer being ethylenically unsaturated, a non-acid functional polar monomer being ethylenically unsaturated, and a terpene phenolic tackifier.

The present application relates to adhesive film. In particular, the present disclosure relates to an adhesive film for producing graphics.

Adhesive films have been widely used in producing graphics or decorations on substrates. For example, adhesive films are used to provide advertisement, logos or company names and information on vehicles such as vans, busses, trains, trams, etc. They may also be used on buildings. Typically, the adhesive film will have to remain in place for an extended period of time up to several years. Accordingly, the graphics produced with the film are exposed to a large variety of weather conditions. Particularly in so called horizontal applications, where the film is applied over a generally horizontal surface such as on the hood of a car, the weathering conditions may be particularly severe. Accordingly, the adhesive film needs to have excellent weathering stability and excellent adhesion characteristics to the surface.

Yet, after use, it is generally desirable that the graphic film can be removed without damaging the surface of the substrate which frequently may be a painted surface. In certain applications, these graphics may be of a significant size. Application of a large image graphic to substrates encounters the problem of entrapped air between the film and the substrate. Anyone who has ever attempted to hang wallpaper can appreciate the frustration that can arise when entrapped air beneath an adhesive-backed film cannot be removed easily. The removal of air bubbles is labor intensive. The art has provided multiple solutions to this problem by providing air-bleed channels in the adhesive. In certain instances, it has been found that the presence of air bleed channels may become visible on the graphic and disturb the appeal of the graphic. Such may occur shortly after application of the film or develop over an extended period of time.

Still further, the surface of the substrate may be uneven requiring good conformability of the film. For example, when the film is used in personalization of vehicles or in decorating vehicles, the film may need to be applied over recesses such as where the license plate is located, over curved surfaces such as over bumpers and/or other complex contours of the substrate. As a result of stress relaxation of the film following the application on the substrate, the adhesive film may lift and pop-up in areas where the surface of the substrate is uneven or has a complex shape. This undesired behavior may become apparent shortly after application or after some time.

### SUMMARY

In one aspect, a precursor composition for an adhesive includes a (meth)acrylate copolymer, made by copolymerization of a monomeric mixture containing an acid functional polar monomer being ethylenically unsaturated and a non-acid functional polar monomer being ethylenically unsaturated, and a terpene phenolic tackifier with an amount ranging from 5 to 60 parts per hundred (pph) wherein the copolymer is equal to 100 parts. The acid functional polar monomer and the non-acid functional polar monomer are included in an amount up to 15 percent by weight based on a total weight of monomeric units in the monomeric mixture, wherein the sum of all monomers in the monomeric mixture equals 100 percent by weight.

In one aspect, an adhesive film includes an adhesive made from the precursor composition.

### BRIEF DESCRIPTION OF THE SEVERAL VIEWS OF THE DRAWINGS

To easily identify the discussion of any particular element or act, the most significant digit or digits in a reference number refer to the FIGURE number in which that element is first introduced.

FIG. 1 illustrates an aspect of the subject matter in accordance with one embodiment.

### DETAILED DESCRIPTION

The present disclosure relates to an adhesive that can be used on a film to provide a very high initial peel adhesion (within 24 to 72 hours dwell time) along with very clean removal from different substrates in the long term after aging (e.g., after 7 days dwell time). Examples of applications for such an adhesive include graphic film applications with graphic film backings, such as polyvinyl chloride (PVC) or polylactic acid (PLA) films, applied to various substrates, such as painted rail panels, clear coats, stainless steel, aluminum, etc. Various other applications may also benefit from an adhesive that can provide a very high initial adhesion but clean removal at the end of the life.

As used herein, the term “clean removal” refers to the absence of visually or tactilely perceptible adhesive residue remaining on a substrate after removal of adhesive test strips (e.g., adhesive laminated on film) for the Aged Peel Adhesion Test Method. More particularly, clean removal is also defined as the absence of a cohesive failure mode during the Aged Peel Adhesion Test Method. Cohesive failure occurs when the peel separation front propagates through the bulk of the adhesive coating, resulting in an adhesive layer remaining on both the substrate and the film of the adhesive test strip.

Various existing adhesives are able to provide very high initial adhesion using pressure sensitive adhesives (PSA). However, existing adhesives with high initial adhesion typically keep building adhesion with time and temperature such that the adhesive fails cohesively on long term removal. This can prevent clean removal after the adhesive thoroughly bonds to the substrate.

The present disclosure provides a precursor composition for adhesive including a (meth)acrylate copolymer made by a copolymerization of a monomeric mixture. The monomeric mixture includes an acid functional polar monomer that is ethylenically unsaturated and a non-acid functional polar monomer that is ethylenically unsaturated. The acid functional polar monomer and the non-acid functional polar monomer are included in an amount up to 15 percent by weight based on a total weight of monomeric units in the monomeric mixture, wherein the sum of all monomers in the monomeric mixture equals 100 percent by weight. The precursor composition also includes a terpene phenolic tackifier with an amount ranging from 5 to 60 parts wherein the copolymer is equal to 100 parts. Amounts of monomers described correspond to dry weight without solvent.

In some embodiments, when the precursor composition is cured and applied between a polymeric film and a metal or painted metal substrate, the peel force is greater than a threshold value at 24 hours and removes cleanly from the substrate after aging at 65.5 °C for 7 days. In some embodiments, at 24 hours at CTH, the peel force is greater than or equal to 550 N/m as measured by the Aged Peel Adhesion Test Method described herein.

As used herein, “CTH” refers to constant temperature and humidity, which may include a room temperature of 23+2 degrees Celsius (°C) at 50% relative humidity (RH).

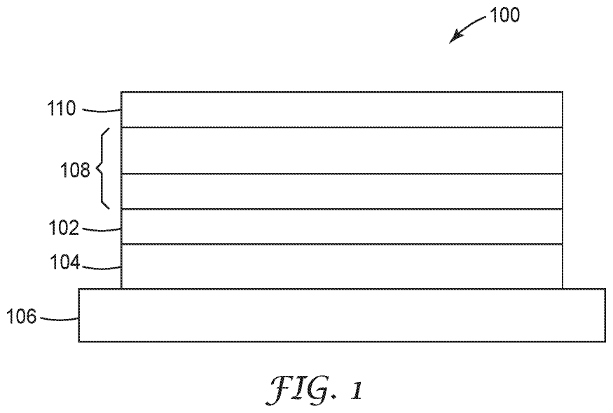

FIG. 1 shows a schematic cross-sectional view of one example of an application for an adhesive film 100 including the adhesive layer 104 according to the present disclosure. The adhesive layer 104 is onto a film layer 102 (e.g., graphic film layer). An overlaminate 108, including an overlaminate film layer and overlaminate adhesive, may be laminated to the graphic film layer 102. A hardcoat layer 110 may be applied to the overlaminate 108.

The film layer 102 may be made of any suitable material, such as a polymeric film. Examples of suitable polymeric films include PVC film and PLA film. A PVC film is typically a plasticized PVC. A PLA film may also include polyvinyl acetate (PVA), for example, as described in U.S. Patent Pub. No. 2022/0169846. The PLA film may also be plasticized.

The film layer 102 may be clear transparent or may be colored. In one particular embodiment, the adhesive film 100 is white and at least the film layer 102 is colored white. White pigments that may be used include titanium dioxide or zinc oxide. In another embodiment, the adhesive film 100 is black and at least the film layer 102 is colored black. Suitable pigments for coloring the film layer 102 black include carbon blacks. In yet a further embodiment, an adhesive film 100 having a metallic look, including a colored metallic look, is provided. A metallic look adhesive film 100 may be provided, for example, by metal particles such as aluminum flakes. The metal particles may be included in the film layer 102. Further, when in addition to the metallic effect a color effect, for example a color other than black or white, is desired a color pigment may typically be added to the film layer 102.

The thickness of the film layer 102 may vary widely but typically is at least 20 micrometer. In a particular embodiment, the film layer 102 may have a thickness of 25 to 100 micrometer. In another embodiment, the thickness may be from 30 micrometer to 80 micrometer or from 30 micrometer to 60 micrometer.

As mentioned above, the film layer 102 may include color pigments such as white pigments, black pigments and/or color pigments other than black and white. Where the film layer 102 includes color pigments, they can be included in the film layer 102 in an amount of 1 to 100 parts per 100 parts by weight of the base film polymer (e.g., PVC or PLA). The film layer 102 may include further optional components such as plasticizers, UV stabilizers, heat stabilizers, acrylic resins, polyesters, surfactants, and rheology modifiers. The film layer 102 may include one or more layers, depending on the specific application. For example, the film layer 102 may include more than one layer, each of them having different color pigments.

The adhesive layer 104 may have a thickness that can vary widely. Typically, the adhesive layer 104 will have a thickness of at least 10 micrometer, for example at least 15 micrometer or at least 20 micrometer. In a typical embodiment the thickness of the adhesive layer 104 is from 15 micrometer to 50 micrometer. In some embodiments, the adhesive layer 104 includes a pressure sensitive adhesive (PSA). Pressure sensitive adhesives (PSAs) may possess one or more of the following properties: (1) aggressive and permanent tack, (2) adherence with no more than finger pressure, (3) sufficient ability to hold onto an adherend, and (4) sufficient cohesive strength. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20 °C). Examples of various adhesives that may be used in the adhesive layer 104 include PSA's, hot melt, or heat activated adhesives that are pressure sensitive at the time of application.

In general, a pressure sensitive adhesive used herein is made from a curable precursor, or precursor composition. The precursor composition includes an acrylic copolymer and typically a tackifier and a crosslinker.

The acrylic copolymer is made by copolymerization of a monomeric mixture, which includes at least an acid functional polar monomer that is ethylenically unsaturated, a non-acid functional polar monomer that is ethylenically unsaturated. In some embodiments, the monomeric mixture also includes a C1-C14 (meth)acrylic acid ester monomer. In at least one embodiment, the monomeric mixture includes:
(a) a C1-C14 (meth)acrylic acid ester monomer;
(b) an acid functional polar monomer that is ethylenically unsaturated; and
(c) a non-acid functional polar monomer that is ethylenically unsaturated.

A “curable precursor” is meant to designate a precursor composition which can be cured using a curing agent or crosslinker to form a pressure sensitive adhesive.

As used herein, “(meth)acryl” is a shorthand term referring to “acryl” and/or “methacryl”. For example, “C₁-C₁₄ (meth)acrylic acid ester monomer” refers to “C₁-C₁₄ acrylic acid ester monomers” and/or “C₁-C₁₄ methacrylic acid ester monomer”.

A “monomer” is any chemical substance which can be characterized by a chemical formula, bearing polymerizable unsaturated groups (including (meth)acrylate groups) which can be polymerized to oligomers or polymers thereby increasing the molecular weight. The molecular weight of monomers can usually simply be calculated based on the chemical formula given.

The C₁-C₁₄ (meth)acrylic acid ester monomer (a) may be a C₁, C₂, C₃, C₄, C₅, C₆, C₇, C₈, C₉, C₁₀, C₁₁, C₁₂, C₁₃ or C₁₄ (meth)acrylic acid ester monomer. The C₁-C₁₄ (meth)acrylic acid ester monomer can be characterized as (meth)acrylic acid ester of an alkyl alcohol, said alcohol containing from 1 to 14 carbon atoms. The term “alkyl” refers to a monovalent group which is a saturated hydrocarbon. The alkyl can be linear, branched, cyclic or combinations thereof. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, 2-ethylhexyl, 2-octyl, isooctyl, and 2-propylheptyl.

The C₁-C₁₄ (meth)acrylic acid ester monomer may be selected from the group consisting of N-butyl (meth)acrylate, methyl (meth)acrylate, ethyl (meth)acrylate, hydroxyethyl (meth)acrylate, hydroxypropyl (meth)acrylate, tert-butyl (meth)acrylate, iso-butyl (meth)acrylate, iso-octyl (meth)acrylate, 2-ethylhexyl (meth)acrylate, 2-methylbutyl(meth)acrylate, isobornyl (meth)acrylate, 2-propylheptyl (meth)acrylate, cyclohexyl (meth)acrylate, benzyl (meth)acrylate, tetrahydrofurfuryl (meth)acrylate, and any mixtures thereof.

The monomer composition may include one type of C₁-C₁₄ (meth)acrylic acid ester monomer. The monomer composition may include as well two or more different types of C₁-C₁₄ (meth)acrylic acid ester monomers, such as, for example, N-butyl acrylate, N-butyl methacrylate, methyl acrylate, methyl methacrylate, tert-butyl acrylate, 2-methylbutyl acrylate, iso-butyl acrylate, iso-octyl acrylate, 2-ethylhexyl acrylate, iso-octyl methacrylate, 2-ethylhexyl methacrylate, ethyl acrylate, hydroxyethyl acrylate, or 2-propylheptyl acrylate.

If only one type of C₁-C₁₄ (meth)acrylic acid ester monomer is used, the monomer composition may include, for example, N-butyl acrylate, ethyl acrylate, hydroxyethyl acrylate, iso-octyl acrylate, 2-ethylhexyl acrylate, 2-methylbutyl acrylate, or iso-butyl acrylate.

Preferably, the C₁-C₁₄ (meth)acrylic acid ester monomer for use in the monomer composition is 2-ethylhexyl acrylate.

The monomer composition includes an acid functional polar monomer (b) that is ethylenically unsaturated. The acid functional group may be an acid per se, such as a carboxylic acid, or a portion may be a salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof.

The acid functional polar monomer for use in the monomer composition may be selected from the group consisting of acrylic acid, methacrylic acid, itaconic acid, fumaric acid, crotonic acid, citraconic acid, maleic acid, oleic acid, B-carboxyethyl (meth)acrylate, 2-sulfoethyl methacrylate, styrene sulfonic acid, 2-acrylamido-2-methylpropane sulfonic acid, vinyl phosphonic acid, and mixtures thereof.

Preferably, the acid functional polar monomer for use in the monomer composition is acrylic acid or methacrylic acid.

Due to their availability, the acid functional polar monomer is generally selected from ethylenically unsaturated carboxylic acids, i.e. (meth)acrylic acids. When even stronger acids are desired, the acidic monomers may include the ethylenically unsaturated sulfonic acids and ethylenically unsaturated phosphonic acids.

The monomer composition may include one type of acid functional polar monomer such as, for example, acrylic acid, methacrylic acid, itaconic acid, or fumaric acid. The monomer composition may include as well two or more different types of acid functional polar monomers.

The monomer composition includes a non-acid functional polar monomer that is ethylenically unsaturated (c).

The non-acid functional polar monomer may be a nitrogen containing non-acid functional polar monomer.

The non-acid functional polar monomer for use herein may be selected from the group consisting of N-vinyl-2-pyrrolidone, or N-vinyl caprolactam, and mixtures thereof.

Preferably, the non-acid functional polar monomer for use herein is selected from the group consisting of N-vinyl-2-pyrrolidone.

The monomer composition may include one type of non-acid functional polar monomer such as, for example, N-vinyl-2-pyrrolidone or N-vinyl caprolactam. The monomer composition may include as well two or more different types of non-acid functional polar monomers.

The amount of the C₁-C₁₄ (meth)acrylic acid ester monomer (a) is from 70 to 98 percent by weight, preferably from 80 to 96 percent by weight, more preferably from 82 to 96 percent by weight, based on the total weight of the monomer composition. The amount of the acid functional polar monomer (b) is from 1 to 15 percent by weight, preferably from 2 to 10 percent by weight, more preferably from 2 to 8 percent by weight, based on the total weight of the monomer composition. The amount of the second polar monomer non-acid functional polar monomer (c) is from 1 to 15 percent by weight, preferably from 2 to 10 percent by weight, based on the total weight of the monomer composition.

The amount of the C₅-C₁₄ (meth)acrylic acid ester monomer (a1) is from 30 to 85 percent by weight, based on the total weight of the monomer composition. The amount of the C₁-C₄ (meth)acrylic acid ester monomer (a2) is from 4 to 60 percent by weight, based on the total weight of the monomer composition.

The amounts of the individual monomers (a), (b), (c), (a1) and (a2) are to be understood as based on the total weight of the monomer composition without any solvent that may optionally be included in the monomer composition.

The weight ratio of the acid functional polar monomer to the non-acid functional polar monomer in the monomer composition may be from 0.5 to 2. The tackifier loading range by weight may be from 25 to 35%, for example, up to about 60 pph, or up to about 50 pph.

The acrylic copolymer used herein is made by polymerization of the monomer composition, typically by free radical polymerization. An initiator for free radical polymerization is typically added to the various monomers (a)-(c), (a1) and (a2) used to form the acrylic copolymer. The polymerization initiator can be a thermal initiator, a photoinitiator, or both. Any suitable thermal initiator or photoinitiator known for free radical polymerization reactions can be used. The initiator is typically present in an amount in the range of 0.01 to 5 percent by weight, in the range of 0.01 to 2 percent by weight, in the range of 0.01 to 1 percent by weight, or in the range of 0.01 to 0.5 percent by weight based on the total weight of the monomer composition. The amount of initiator is to be understood as based on the total weight of the monomer composition without any solvent that may optionally be included in the monomer composition.

In some embodiments, a thermal initiator is used. Thermal initiators can be water-soluble or water-insoluble (i.e., oil-soluble) depending on the particular polymerization method used. Suitable water-soluble initiators include, but are not limited to, persulfates such as potassium persulfate, ammonium persulfate, sodium persulfate, and mixtures thereof; an oxidation-reduction initiator such as the reaction product of a persulfate and a reducing agent such as a metabisulfite (e.g., sodium metabisulfite) or a bisulfate (e.g., sodium bisulfate); or 4,4′-azobis(4-cyanopentanoic acid) and its soluble salts (e.g., sodium or potassium). Suitable oil-soluble initiators include, but are not limited to, various azo compounds such as those commercially available under the trade designation VAZO from E. I. DuPont de Nemours Co. including VAZO 67, which is 2,2′-azobis(2-methylbutane nitrile), VAZO 64, which is 2,2′-azobis(isobutyronitrile), and VAZO 52, which is (2,2′-azobis(2,4-dimethylpentanenitrile); and various peroxides such as benzoyl peroxide, cyclohexane peroxide, lauroyl peroxide, and mixtures thereof.

In some embodiments, a photoinitiator is used. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2,-diethoxyacetophenone or 2,2-dimethoxy-2-phenylacetophenone (commercially available under the trade designation Omnirad BDK from IGM resins, Netherlands. Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(0-ethoxycarbonyl) oxime. Other suitable photoinitiators include, for example, 1-hydroxycyclohexyl phenyl ketone (Omnirad 184), bis(2,4,6-trimethylbenzoyl)phenylphosphineoxide (Omnirad 819), 1-[4-(2-hydroxyethoxy)phenyl]-2-hydroxy-2-methyl-1-propane-1-one (Omnirad 2959), 2-benzyl-2-dimethylamino-1-(4-morpholinophenyl) butanone (Omnirad 369), 2-methyl-1-[4-(methylthio)phenyl]-2-morpholinopropan-1-one (Omnirad 907), and 2-hydroxy-2-methyl-1-phenyl propan-1-one (Omnirad 1173).

The monomer composition may optionally further contain a chain transfer agent to control the molecular weight of the resultant acrylic copolymer. Examples of useful chain transfer agents include, but are not limited to, carbon tetrabromide, alcohols such as isopropyl alcohol (IPA), mercaptans such as isooctylthioglycolate, and mixture thereof. If used, the monomer composition may include up to 5 percent by weight of a chain transfer agent, based on the total weight of the monomer composition. For example, the monomer composition can contain 0.01 to 0.5 percent by weight, 0.05 to 0.5 percent by weight, or 0.05 to 0.2 percent by weight of a chain transfer agent, based on the total weight of the monomer composition.

The monomer composition used to form the acrylic copolymer can include an organic solvent or can be either free or essentially free of an organic solvent. As used herein, the term “essentially free” in reference to an organic solvent means that the organic solvent is present in an amount less than 5 percent by weight, less than 4 percent by weight, less than 3 percent by weight, less than 2 percent by weight, or less than 1 percent by weight, based on the total weight of the monomer composition. Examples of suitable organic solvents include, but are not limited to, methanol, tetrahydrofuran, ethanol, isopropanol, heptane, acetone, methyl ethyl ketone, methyl acetate, ethyl acetate, toluene, xylene, and ethylene glycol alkyl ether. Those solvents can be used alone or as mixtures thereof.

The acrylic copolymer can be prepared by a variety of conventional free radical polymerization methods, including solution, bulk (i.e., with little or no solvent), dispersion, emulsion, and suspension processes. The particular method used may be influenced by the monomer composition and the molecular weight of the acrylic copolymer. The resulting acrylic copolymer can be a random or a block copolymer. In many embodiments, the acrylic copolymer is a random copolymer.

In some preferred embodiments, the acrylic copolymer is made by solvent polymerization, with the monomer composition used to form the acrylic copolymer including an organic solvent. The amount of solvent may be, for example, from 50 to 90 percent by weight, based on the total weight of the monomer composition.

Generally, the glass transition temperature of an acrylic copolymer can be calculated from the glass transition temperature of the homopolymers of the individual monomers of the monomer composition by using the Fox Equation, i.e.:

1/T_{g}=ΣWᵢ/T_{g,i}.

In this equation, T_{g} is the glass transition temperature of the acrylic copolymer, Wᵢ is the weight fraction of the individual monomer i, and T_{g,i} is the glass transition temperature of the homopolymer of the individual monomer i. All glass transition temperatures may be either in Kelvin (K) or in °C. For two monomers A and B, the Fox equation reduces to

1/T_{g}=W_{A}/T_{g,A}+W_{B}/T_{g,B},
where W_{A} and W_{B} are the weight fractions of monomers A and B, respectively, T_{g,A} and T_{g,B} are the glass transition temperature of the homopolymers of monomers A and B, respectively, and T_{g} is the glass transition temperature of the acrylic copolymer.

Alternatively, the glass transition temperature can be measured in a variety of known ways, including, e.g., through differential scanning calorimetry (DSC) or dynamic mechanical thermal analysis (DMTA).

The glass transition temperature of the acrylic copolymer for use herein is at least-30 °C, as calculated using the Fox Equation. The glass transition temperature of the acrylic copolymer may be −30 °C (minus 30 °C), or higher than −30 °C, as calculated using the Fox Equation. For example, the glass transition temperature of the acrylic copolymer may be −30 °C, or −27 °C, or −25 °C, or −22 °C, or −20 °C, or −18 °C, or −15 °C, or higher, as calculated using the Fox Equation. The glass transition temperature of the acrylic copolymer may be from −30 °C to 10 °C, or from −30 °C to 0 °C, as calculated using the Fox Equation. The glass transition temperature of the acrylic copolymer is calculated using the Fox Equation from the glass transition temperature of the homopolymers of the individual monomers of the monomer composition which is used for copolymerization of the acrylic copolymer.

The acrylic copolymer of the curable precursor used for making the pressure sensitive adhesive may have a weight average molecular weight of from 300 000 to 1 500 000 g/mol, or from 400 000 to 1 200 000 g/mol, or from 500 000 to 1 000 000 g/mol.

In some embodiments, the acrylic copolymer may have a weight average molecular weight of from 500 000 to 700 000 g/mol.

Unless otherwise indicated, the weight average molecular weight of the acrylic copolymer of the curable precursor used for making the pressure sensitive adhesive is determined by conventional gel permeation chromatography (GPC) using appropriate techniques well known to those skilled in the art.

The curable precursor from which the pressure sensitive adhesive for use herein is made includes a crosslinker.

The crosslinker may increase shear or cohesive strength of the acrylic pressure sensitive adhesive. Generally, any suitable crosslinker may be used. For example, chemical or thermal crosslinkers may be used including covalent crosslinkers such as bisamides, epoxies, multifunctional isocyanates and melamines; and ionic crosslinkers such as multi-functional amines, metal oxides, and organo-metallic chelating agents (e.g., aluminum acetylacetonate). An example for a bisamide is 1,1′-(1,3-phenylene dicarbonyl)-bis-(2-methylaziridine) (CAS No. 7652-64-4), a multi-functional aziridine. Such chemical or thermal crosslinkers can be added into solvent-based PSAs after polymerization and activated by heat during oven drying of the coated adhesive.

In another embodiment, chemical or thermal crosslinkers which rely upon free radicals to carry out the crosslinking reaction may be employed. Reagents such as, for example, peroxides serve as a precursor source of free radicals. When heated sufficiently, these precursors will generate free radicals which bring about a crosslinking reaction of the polymer chains. A common free radical generating reagent is benzoyl peroxide. Free radical generators are required only in small quantities, but generally require higher temperatures to complete the crosslinking reaction than those required for the bisamide 1,1′-(1,3-phenylene dicarbonyl)-bis-(2-methylaziridine).

Another type of chemical crosslinker is a photosensitive crosslinker which is activated by high intensity ultra-violet (UV) light. Two common photosensitive crosslinkers used for hot melt acrylic PSAs are benzophenone and 4-acryloxybenzophenone which is copolymerized into the PSA polymer. Another photocrosslinker, which can be post-added to the solution polymer and activated by UV light is a triazine; for example, 2,4-bis(trichloromethyl)-6-(4-methoxy-phenyl)-s-triazine. These crosslinkers are activated by UV light generated from artificial sources such as medium pressure mercury lamps.

Aside from thermal or photosensitive crosslinkers, crosslinking may also be achieved using high energy electromagnetic radiation such as gamma or e-beam radiation.

A physical crosslinking agent may also be used. In one embodiment, the physical crosslinking agent is a high T_{g} macromer such as those based upon polystyrene and polymethylmethacrylate.

Preferred crosslinkers for use herein are aziridine compounds, such as bisaziridine. A preferred aziridine compound is 1,1′-(1,3-phenylenedicarbonyl)bis [2-methylaziridine].

Further suitable aziridine crosslinkers are described in US 2010/0227969 A1.

The amount of crosslinker included depends on well-understood factors such as the desired degree of crosslinking and the relative effectiveness of the crosslinker in the particular system.

The amount of crosslinker may be from 0.001 to 2.5 percent by weight, based on the total weight of the acrylic copolymer and the crosslinker. The amount of crosslinker is to be understood as based on the total weight of the acrylic copolymer and the crosslinker without any solvent that may optionally be included in the curable precursor.

For example, in some embodiments, the curable precursor from which the pressure sensitive adhesive used herein is made includes from 0.001 to 2.5 percent by weight of an aziridine crosslinker such as 1,1′-(1,3-phenylenedicarbonyl)bis [2-methylaziridine], based on the total weight of the acrylic copolymer and the crosslinker.

The curable precursor may optionally include a solvent. Examples of suitable solvents include, but are not limited to, methanol, tetrahydrofuran, ethanol, isopropanol, heptane, acetone, methyl ethyl ketone, methyl acetate, ethyl acetate, toluene, xylene, and ethylene glycol alkyl ether. Those solvents can be used alone or as mixtures thereof.

The solvent content typically is from to 50 to 90% by weight, based on the total amount of the curable precursor.

The pressure sensitive adhesive for use herein may also contain one or more conventional additives such as tackifiers, plasticizers, dyes, pigments, antioxidants, UV stabilizers and fillers.

Any suitable tackifier may be used for the pressure sensitive adhesives. In particular, the tackifier is a terpene phenolic tackifier. Other types of tackifiers may include rosin acids, rosin esters, esters of hydrogenated rosins, terpene phenolic resins, hydrocarbon resins, and cumarone indene resins. The type and amount of tackifier can affect properties such as wetting, bonding range, bond strength, heat resistance and specific adhesion. In some embodiments, the tackifier has a softening point within a range of 95 °C to 135 °C, such as about 125 °C.

The crossover modulus of the pressure sensitive adhesive for use herein may be at least 50 000 Pa.

Typically, the crossover modulus of the pressure sensitive adhesive for use herein is up to 600 000 Pa.

In some embodiments, the crossover modulus of the pressure sensitive adhesive for use herein is from 50 000 to 600 000 Pa.

The crossover modulus can be determined by rheological measurements, by small amplitude oscillatory shear tests.

The crossover modulus is the point in a frequency sweep, a time sweep, or a temperature ramp of small amplitude oscillatory shear tests where the storage modulus (G′) is equal to the loss modulus (G″) (units: pascals).

The crossover angular frequency (@) is the frequency in a frequency sweep of small amplitude oscillatory shear tests at which the storage modulus is equal to the loss modulus (units: radians per second).

The adhesive layer should be removable, i.e., allow removal of the graphic film after use. For purposes of this disclosure, an adhesive is considered to be “removable”, if after final application to an intended substrate the sheet material can be removed without damage to the substrate or without adhesive residue remaining on the substrate at the end of the intended life of the sheet material at a rate in excess of 25 feet/hour (7.62 meters/hour) by hand with the optional use of heat.

In a particular embodiment, the adhesive layer is a repositionable adhesive layer. For the purposes of this disclosure, “repositionable” refers to the ability to be, at least initially, repeatedly adhered to and removed from a substrate without substantial loss of adhesion capability. A repositionable adhesive usually has a peel strength, at least initially, to the substrate surface lower than that for a conventional aggressively tacky PSA. Suitable repositionable adhesives include the adhesive types used on CONTROLTAC Plus Film brand and on SCOTCHLITE Plus Sheeting brand, both made by 3M Company, St. Paul, Minnesota, USA.

In a particular embodiment, the adhesive layer in connection with the present disclosure is a topologically structured adhesive layer or an adhesive layer having at least one microstructured surface. In particular, the adhesive layer has a network of channels between the substrate surface on which the adhesive film is being applied and the adhesive layer. The presence of such channels allows air to pass laterally through the adhesive layer and thus allows air to escape from beneath the multi-layer sheet material and the surface substrate during application. The channels are typically produced in the adhesive layer through corresponding ridges of the release liner protecting the adhesive layer prior to application of the adhesive film. Accordingly, reference is made to the detailed description below regarding the release liner.

The adhesive layer is protected with a release liner. The release liner is preferably adhesive-repellant and more specifically includes paper or film, which has been coated or modified with compounds of low surface energy relative to the adhesive applied. Organo silicone compounds, fluoropolymers, polyurethanes and polyolefins can serve this purpose. The release liner can also be a polymeric sheet produced from polyethylene, polypropylene, PVC, polyesters with or without the addition of adhesive-repellant compounds.

The adhesive film 100 may include a release liner (not shown). In a particular embodiment, the release liner has a micro-structured or micro-embossed pattern. For example, the release liner includes on the major surface contacting the adhesive layer (i.e., on its release side facing the adhesive layer) a series of ridges along at least two in-plane directions whereby the ridges are interconnected thereby defining a number of recesses enclosed by ridges. The ridges will typically have an average height of not more than 30 micrometers. Typically, the average height may be between 5 and 20 micrometers. The average distance between ridges along an in-plane direction of the release liner may be between 50 and 400 micrometers when measured at the top. The geometry or shape of the ridges is not particularly critical and includes, in cross-section, curved, rectangular, trapezoidal, triangular, bimodal, and the like.

In a particular embodiment, the release liner includes ridges along two in-plane directions. A first series of ridges may be formed by repeating ridges along a first in-plane direction and a second series of ridges may be formed by repeating ridges along a second in-plane direction. The ridges of the two series connect to each other at intersections, thereby defining a pattern of enclosed recesses. The enclosed recesses may have the shape of a rectangle or square. Alternative shapes of the recesses are possible as well and may be formed by additional series of ridges. In a particular embodiment the microstructure formed by the ridges on the surface of the release liner may be superimposed with a further pattern defined by discrete small depressions within the recesses defined by the interconnecting ridges. The microstructure of the release liner may be formed by any suitable means including in particular by embossing the liner with an appropriate tool. Methods for producing release liners with a desired microstructure as described herein can be found in for example EP 951 518 and US 2008/0299346.

In some embodiments of the adhesive film 100 disclosed herein, the adhesive film 100 includes a primer layer (not shown) arranged between the film layer 102 and the adhesive layer 104. The primer layer may include an aminoplast and a polyester and/or a curing product thereof, for example. The primer layer may contribute to the bonding between the adhesive layer 104 and the film layer 102.

The overlaminate 108 and hardcoat layer 110 may provide clear transparent layers on a second major side of the film layer 102 opposite a first major side adjacent to the adhesive layer 104. Such layers may serve to enhance weatherability of the adhesive film 100, particularly where the adhesive film 100 is applied horizontally such as a vehicle exterior. Suitable layers may be applied by any common application method including laminating, coating, screen printing and the like. Typically, the layers will include a polymer resin. Suitable resins include PVC, acrylic polymers and polyester such as polyethylene terephthalate and combinations thereof. The thickness of the layers may vary widely but is typically at least 0.5 micrometer. In a particular embodiment, the thickness is from 1 to 50 micrometers.

The adhesive film 100 may be made in any suitable manner. In one example, the adhesive film 100 is typically made using a method including (i) applying on a carrier web (or liner) in the order given: the optional layers (overlaminate 108 and hardcoat layer 110), the film layer 102, the optional primer layer, the adhesive layer 104 and the release liner and (ii) removing the carrier web. The carrier web is typically selected so as to obtain the desired finish of the adhesive film 100 such as a gloss or matte finish, for example. Two or more layers of the adhesive film 100 may be provided in one application step and/or individual layers of the adhesive film 100 may be applied in separate application steps. The carrier web used in the manufacturing method includes typically a paper or film backing provided with a release coating enabling stripping and removing of the carrier web typically when all layers have been applied. Suitable release coatings on the carrier web include in particular thermoset urea resins and acrylic resins.

The adhesive film 100 as described above is typically used to produce a graphic on a substrate. Further disclosed herein is a method for producing a graphic on a substrate, the method including
(i) providing an adhesive film as disclosed herein,
(ii) removing the release liner, and
(iii) applying the adhesive film on the substrate.

The graphic may be an image graphic or a text message or a combination thereof.

The graphic may have any size but the adhesive films 100 in connection with this disclosure are particularly suitable for producing large size graphics for example extending over an area of at least 1 m² or at least 2 m².

The adhesive film 100 is particularly suitable for application on a substrate with an uneven surface. Generally, the adhesive film 100 will then be conforming to the uneven surface of the substrate. Examples of uneven surfaces include substrates that have recesses, rivets, or areas of curvature.

The adhesive film 100 may be applied to a large variety of substrates. Typical applications include applying the film onto building (exterior or interior) as well as on vehicles including in particular motor vehicles such as trains, busses, trams, cars, vans, trucks as well as airplanes. In connection with this disclosure, the method of producing a graphic includes producing a graphic having a plurality of discrete units of colored adhesive film 100. In this method, the colored adhesive film 100 of each of the discrete units includes the adhesive film 100.

### EXAMPLES

Unless otherwise noted or readily apparent from the context, all parts, percentages, ratios, etc. in the Examples and the rest of the specification are by weight. Abbreviations used herein include: pph=parts per hundred out of 100 parts of copolymer (e.g., monomers in copolymer).

TABLE 1
Materials Used in the Examples

| Abbreviation | Description | Source |
|---|---|---|
| TP2019 | Sylvares TP 2019 Terpene Phenol - | KRATON - Houston, Texas, USA |
| | tackifier | |
| TP96 | Sylvares TP 96 Terpene Phenol - | KRATON - Houston, Texas, USA |
| | tackifier | |
| Vazo 67 initiator | Vazo ™ 67 is an oil soluble | ChemPoint - Bellevue, Washington, |
| | azonitrile compound | USA |
| Fruehauf Panel | Painted Aluminum Test Panels | Fruehauf, Indianapolis, IN, USA |
| Rail Paint Panel | Painted Aluminum (Alexit Top | Mankiewicz Gebr. & Co. (GmbH & |
| | Coat 343-6A, Alexit Clearcoat 341- | Co. KG) - Hamburg, Germany |
| | 5A) | |
| Aluminum Panel | Grade 6005-T6, N2 finish, 3 mm | As commercially available |
| | thickness | |
| Stainless Steel Panel | ASTM AISI 304, 2B finish, 2 mm | As commercially available |
| | thickness | |
| IOA | Isooctyl acrylate | Sigma-Aldrich Co., LLC, St. Louis, |
| | | MO, USA |
| 2EHA | 2-ethylhexyl acrylate | BASF LLC |
| MA | Methyl acrylate | Sigma-Aldrich Co., LLC, St. Louis, |
| | | MO, USA |
| BA | Butyl Acrylate | BASF LLC |
| AA | Acrylic Acid | Sinopharm Chemical Reagent Co., Ltd. |
| NVP | N-Vinyl pyrrolidone | Tokyo Chemical Industry Co., LTD |
| | | (TCI) Tokyo, Japan |
| EtOAc | Ethyl acetate | Sigma-Aldrich Co., LLC, St. Louis, |
| | | MO, USA |
| IPA | Isopropyl Alcohol - Chain Transfer | Shell Chemicals, USA |
| | Agent | |
| PVC | Acrylic and Ter-Polymer | 3M Company, St. Paul, MN, USA |
| PLA+ | Polylactic acid (PLA) and | 3M Company, St. Paul, MN, USA |
| | polyvinyl acetate (PVA) polymers, | |
| | as described in U.S. Patent Pub. | |
| | No. 2022/0169846. | |
| 8993 | SG 8993 - Polyester based | 3M Company, St. Paul, MN, USA |
| | overlaminate | |
| 8588G | 8588G Anti-Graffiti overlaminate | 3M Company, St. Paul, MN, USA |
| | film | |
| 8518 | 8518 - PVC based overlaminate | 3M Company, St. Paul, MN, USA |
| Bisaziridine | Bisaziridine crosslinker - 1,1′-(1,3- | 3M Company, St. Paul, MN, USA |
| crosslinker | phenylenedicarbonyl)bis[2- | |
| | methylaziridine] | |

### Test Methods

### Aged Peel Adhesion Test Method

Substrate panels were cleaned by wiping with isopropyl alcohol and a Kimwipe™ tissue and allowed to dry at ambient condition for 10 minutes prior to applying peel test strips. Adhesion test strips were cut from the laminated experimental films with the dimensions of 2.54 cm by 15.24 cm. The test strips were applied to a clean substrate panel by applying hand pressure with a plastic squeegee once in each direction along the length of the strip, ensuring that no air remains trapped under the test strip. The test panels were then either subjected to environmental aging for 24 hours at constant temperature and humidity (CTH) (23+2 °C and 50±5% RH), 72 hours at constant temperature and humidity, or for 7 days at 65.5 °C. Peel adhesion strength was measured at constant temperature and humidity at a 180° peel angle using an Instron load frame (available from Instron, Norwood, MA) at a crosshead speed of 305 mm/minute. The peel strengths are expressed in N/m. Each example test result was the average result of 3 peel tests.

### Tan Delta Test Method

The tan delta at 100 °C was measured using a DHR-3 rheometer (TA Instruments-New Castle, DE, US). Twelve layers of the adhesive with the backing were laminated on top of each other. A 20 mm diameter circle was punched out. The 20 mm diameter disc was loaded in between a 20 mm top plate and a bottom Peltier plate on the rheometer. The sample was heated to 100 °C using the Peltier plate, and after a dwell time of 120 seconds the sample was tested with a 1500 g normal force and strain rate of 1 radians/s. The tan delta was recorded as function of time and the recorded value was an average of 6 readings per example.

### Example Preparation

### Base Adhesive Examples BA1-BA5 and BA7-BA9 and BA11-BA12

Adhesive BA1 to BA5 were prepared in a similar manner as described in the following paragraph for BA7 to BA9, BA11, and BA12, except the scale of the preparation for BA1 to BA5 was at production scale (4000 gallon capacity reactor).

Monomers (ca. 150 g) and Vazo 67 initiator (0.15 pph, or 0.225 g) were added to a 1-L amber glass bottle with the relative masses as shown in Table 2. Isopropyl alcohol was added to act as a chain transfer agent to control the final IV of the copolymers. Ethyl acetate (EtOAc) was added so that the total monomer concentration targeted 50% by mass (total monomer+solvent solution=ca. 300 g). The contents of the bottle were thoroughly mixed, and the solution was degassed by bubbling a constant stream of nitrogen gas through the solution for two minutes. The bottle was sealed using a Teflon-lined cap and placed in a water bath at 60 °C for 24 hours. After 24 hours, the bottle was removed, the solution was (optionally) diluted with EtOAc, and the polymer was analyzed via IV (inherent viscosity), (see Table 2).

TABLE 2
Example Adhesives Composition and Properties

| | | | | | | | | | | AA/NVP | AA/NVP |
|---|---|---|---|---|---|---|---|---|---|---|---|
| | | | | | | | IPA | IV | Solids | Weight | Mole |
| Adhesive | IOA | 2EHA | MA | BA | AA | NVP | (pph) | (dL/g) | (%) | Ratio | Ratio |
| BA1 | 93 | 0 | 0 | 0 | 7 | 0 | 0 | 0.8 | 40 | NA | NA |
| BA2 | 93 | 0 | 0 | 0 | 7 | 0 | 0 | 1.6 | 29 | NA | NA |
| BA3 | 57.5 | 0 | 35 | 0 | 7.5 | 0 | 0 | 1.6 | 31 | NA | NA |
| BA4 | 65 | 0 | 30 | 0 | 5 | 0 | 0 | 1.6 | 26 | NA | NA |
| BA5 | 0 | 93 | 0 | 0 | 7 | 0 | 2.5 | 0.8 | 39 | NA | NA |
| BA7 | 0 | 91 | 0 | 0 | 3 | 6 | 2 | 0.8 | 33 | 0.5 | 0.77 |
| BA8 | 0 | 91 | 0 | 0 | 4.5 | 4.5 | 2 | 0.8 | 33 | 1 | 1.54 |
| BA9 | 0 | 91 | 0 | 0 | 4.5 | 4.5 | 0 | 1.3 | 33 | 1 | 1.54 |
| BA11 | 0 | 91 | 0 | 0 | 5.5 | 3.5 | 2 | 0.8 | 33 | 1.57 | 2.43 |
| BA12 | 0 | 0 | 0 | 0 | 6 | 3 | 2.25 | 0.8 | 33 | 2 | 3.09 |

### Adhesive Film Examples EX1-EX24 and CE1-CE25

The adhesive layer for examples and comparative examples were prepared as described. The adhesive solution was further diluted with a tackifier, shown in Table 3, 4, 5, and 6, and additional EtOAc as needed to reach the desired percent solids for sample coating. A bisaziridine crosslinker solution was added to the adhesive solution which was then mixed for approximately 10 minutes according to Tables 3-6. The resulting solution was then coated onto a release liner which was siliconized on one side and provided with 3M COMPLY microchannel pattern structure and 3M CONTROLTAC non-adhesive protrusions, commercially available in products such as 3M Wrap Film Series 2080 from 3M Company, St. Paul, MN. A notched bar and a gap setting were used to achieve the target final coating weight after drying. The adhesive coating on the liner was placed in a forced air oven and dried at 87.8 °C for 10 minutes to evaporate solvent and leave a desired thickness and dried adhesive coating weight according to Tables 3-6.

EX1-EX17 and CE1-CE24 were constructed according to Tables 3 and 5 where the adhesive layer was adhered to a 50-micrometer polyvinylchloride (PVC) film and then a 8518 overlaminate was adhered to the PVC film. The release liner was then removed, and the remaining construction was adhered to a Fruehauf panel.

EX18-EX24 and CE25 were constructed according to Tables 4 and 6 where the adhesive layer was adhered to the film, the overlaminate adhered the film, and then the release liner was removed, and the remaining construction was adhered to the substrate identified in Tables 3 and 5. Some constructions include a PLA+ film.

TABLE 3
Example Preparation and Composition Details

| | | | Crosslinker | Adhesive |
|---|---|---|---|---|
| | | TP2019 | Ratio (g | Coating |
| | | Loading | crosslinker to | Weight |
| Examples | Adhesive | (pph) | g polymer) | (g/m²) |
| EX1 | BA9 | 20 | 0.0012 | 40.7 |
| EX2 | BA9 | 35 | 0.0014 | 40.7 |
| EX3 | BA9 | 50 | 0.0016 | 40.7 |
| EX4 | BA9 | 28 | 0.0010 | 36.2 |
| EX5 | BA8 | 20 | 0.0012 | 36.2 |
| EX6 | BA8 | 35 | 0.0014 | 36.2 |
| EX7 | BA8 | 50 | 0.0016 | 36.2 |
| EX8 | BA8 | 35 | 0.0012 | 36.2 |
| EX9 | BA11 | 25 | 0.0014 | 36.2 |
| EX10 | BA11 | 30 | 0.0014 | 36.2 |
| EX11 | BA11 | 35 | 0.0014 | 36.2 |
| EX12 | BA12 | 25 | 0.0014 | 36.2 |
| EX13 | BA12 | 30 | 0.0014 | 36.2 |
| EX14 | BA12 | 35 | 0.0014 | 36.2 |
| EX15 | BA7 | 25 | 0.0014 | 36.2 |
| EX16 | BA7 | 30 | 0.0014 | 36.2 |
| EX17 | BA7 | 35 | 0.0014 | 36.2 |

TABLE 4
Example Preparation and Composition Details with different substrates

| | | | Crosslinker | | | | |
|---|---|---|---|---|---|---|---|
| | | | Ratio (g | Adhesive | | | |
| | | TP2019 | crosslinker | Coating | | | |
| | | Loading | to g | Weight | | | |
| Examples | Adhesive | (pph) | polymer) | (g/m²) | Film | Overlaminate | Substrate |
| EX18 | BA8 | 35 | 0.0014 | 36.2 | PVC | 8993 | Stainless |
| | | | | | | | Steel |
| EX19 | BA8 | 35 | 0.0014 | 36.2 | PVC | 8588G | Stainless |
| | | | | | | | Steel |
| EX20 | BA8 | 35 | 0.0014 | 36.2 | PVC | 8993 | Aluminum |
| EX21 | BA8 | 35 | 0.0014 | 36.2 | PVC | 8588G | Aluminum |
| EX22 | BA8 | 35 | 0.0014 | 36.2 | PLA+ | 8993 | Rail |
| | | | | | | | Painted |
| EX23 | BA8 | 35 | 0.0014 | 36.2 | PLA+ | 8588G | Rail |
| | | | | | | | Painted |
| EX24 | BA8 | 25 | 0.0014 | 36.2 | PLA+ | 8588G | Fruehauf |

TABLE 5
Comparative Example Preparation and Composition Details

| | | | | Crosslinker | |
|---|---|---|---|---|---|
| | | | | Ratio (g | Adhesive |
| | | | Tackifier | crosslinker | Coating |
| Comparative | | Tack- | Loading | to g | Weight |
| Example | Adhesive | ifier | (pph) | polymer) | (g/m²) |
| CE1 | BA1 | TP2019 | 16 | 0.0015 | 36.2 |
| CE2 | BA1 | TP2019 | 16 | 0.0015 | 42.6 |
| CE3 | BA1 | TP2019 | 20 | 0.0015 | 36.2 |
| CE4 | BA1 | TP2019 | 24 | 0.0015 | 36.2 |
| CE5 | BA1 | TP2019 | 33.3 | 0.0015 | 36.2 |
| CE6 | BA2 | TP2019 | 16 | 0.0009 | 36.2 |
| CE7 | BA2 | TP2019 | 20 | 0.0009 | 36.2 |
| CE8 | BA2 | TP2019 | 24 | 0.0009 | 36.2 |
| CE9 | BA2 | TP2019 | 33.34 | 0.0009 | 36.2 |
| CE10 | BA2 | TP96 | 24 | 0.0009 | 36.2 |
| CE11 | BA2 | TP96 | 32 | 0.0009 | 36.2 |
| CE12 | BA2 | TP96 | 50 | 0.0009 | 36.2 |
| CE13 | BA3 | TP2019 | 8 | 0.0009 | 36.2 |
| CE14 | BA3 | TP2019 | 16 | 0.0009 | 36.2 |
| CE15 | BA3 | TP2019 | 24 | 0.0009 | 36.2 |
| CE16 | BA4 | TP2019 | 16 | 0.0009 | 36.2 |
| CE17 | BA4 | TP2019 | 24 | 0.0009 | 36.2 |
| CE18 | BA4 | TP2019 | 33.3 | 0.0009 | 36.2 |
| CE19 | BA5 | TP2019 | 0 | 0.0014 | 36.2 |
| CE20 | BA5 | TP2019 | 20 | 0.0014 | 36.2 |
| CE21 | BA5 | TP2019 | 25 | 0.0014 | 36.2 |
| CE22 | BA5 | TP2019 | 30 | 0.0014 | 36.2 |
| CE23 | BA5 | TP2019 | 35 | 0.0014 | 36.2 |
| CE24 | BA5 | TP2019 | 50 | 0.0014 | 36.2 |

TABLE 6
Comparative Example Preparation and Composition Details with different substrates

| | | | Crosslinker | | | | |
|---|---|---|---|---|---|---|---|
| | | | Ratio (g | Adhesive | | | |
| | | TP2019 | crosslinker | Coating | | | |
| Comparative | | Loading | to g | Weight | | | |
| Example | Adhesive | (pph) | polymer) | (g/m²) | Film | Overlaminate | Substrate |
| CE25 | BA1 | 16 | 0.0014 | 36.2 | PLA+ | 8588G | Fruehauf |

### Results

Example adhesive coatings EX1-EX24 exhibit high initial (24 hour or 72 hour CTH dwell) adhesion. Despite initial adhesion generally above 550 N/m, EX1-EX24 have clean removal from the substrates after conditioning at 65.5 °C for 7 days. Notably, the build in peel force after elevated temperature aging (7 days at 65.5 °C) was low for EX1-EX24, generally less than a 100% increase. This lower adhesion build appears to facilitate clean removal of the example adhesive coatings. The complimentary attractive acid-base interactions between the AA and NVP monomers in EX1-EX24 seem to increase the cohesive strength of the example adhesive coatings, reducing the occurrence of cohesive failures.

In Tables 8 and 10, different combinations of backing film, overlaminate and substrate were investigated. The substrate, overlaminate and the backing film seem to have a significant effect on the final peel adhesion. Comparing EX24 and CE25, which used the same film, overlaminate, and substrate, EX24 had higher initial adhesion and still displayed clean removal after 7 day/65.5 °C oven aging.

TABLE 7
Example Peel Strength and Rheology Results

| | Peel Strength Results | | | | | |
|---|---|---|---|---|---|---|
| | 24 hour | | | | | |
| | peel | 24 hour | 7 days/65.5 °C | 7 day | Rheology Results | |
| | Force | Failure | Peel Force | Failure | Adhesion | Tan Delta |
| Examples | (N/m) | Mode | (N/m) | Mode | Build % | @100 °C |
| EX1 | 594.5 | Clean | 755.9 | Clean | 27 | — |
| EX2 | 779.5 | Clean | 948.8 | Clean | 22 | — |
| EX3 | 500.0 | Clean | 1118.1 | Clean | 124 | — |
| EX4 | 669.3 | Clean | 787.4 | Clean | 18 | 0.51 |
| EX5 | 704.7 | Clean | 881.9 | Clean | 25 | 0.48 |
| EX6 | 748.0 | Clean | 862.2 | Clean | 15 | 0.28 |
| EX7 | 720.5 | Clean | 1043.3 | Clean | 45 | 0.75 |
| EX8 | 700.8 | Clean | 909.4 | Clean | 30 | 0.51 |
| EX9 | 586.6 | Clean | 881.9 | Clean | 50 | 0.4 |
| EX10 | 748.0 | Clean | 1200.8 | Clean | 60 | 0.44 |
| EX11 | 791.3 | Clean | 1248.0 | Clean | 58 | 0.46 |
| EX12 | 720.5 | Clean | 1318.9 | Clean | 83 | 0.47 |
| EX13 | 681.1 | Clean | 1405.5 | Clean | 107 | 0.43 |
| EX14 | 685.0 | Clean | 1224.4 | Clean | 78 | 0.46 |
| EX15 | 622.0 | Clean | 815.0 | Clean | 31 | 0.47 |
| EX16 | 689.0 | Clean | 846.5 | Clean | 23 | 0.56 |
| EX17 | 779.5 | Clean | 1043.3 | Clean | 34 | 0.55 |

TABLE 8
Example Peel Strength and Rheology Results with different substrates

| | | | | | 7 | | |
|---|---|---|---|---|---|---|---|
| | | | | | days/65.5 °C | | |
| | 24 hr Peel | 24 hr | 72 hr Peel | 72 hr | Peel | 7 day | Tan |
| | Adhesion | Failure | Adhesion | Failure | Adhesion | Failure | Delta |
| Example | (N/m) | Mode | (N/m) | Mode | (N/m) | Mode | @100 °C |
| EX18 | 1082.7 | Clean | NA | NA | 1378.0 | Clean | 0.28 |
| EX19 | 1244.1 | Clean | NA | NA | 1496.1 | Clean | 0.28 |
| EX20 | 779.5 | Clean | NA | NA | 905.5 | Clean | 0.28 |
| EX21 | 1141.7 | Clean | NA | NA | 1220.5 | Clean | 0.28 |
| EX22 | NA | | 992.1 | Clean | 988.2 | Clean | 0.42 |
| EX23 | NA | | 1149.6 | Clean | 996.1 | Clean | 0.42 |
| EX24 | NA | | 1043.3 | Clean | 1259.8 | Clean | 0.39 |

TABLE 9
Comparative Example Peel Strength and Rheology Results

| | Peel Strength Results | | | | | |
|---|---|---|---|---|---|---|
| | 24 hour | | 7 | | | |
| | peel | 24 hour | days/65.5 °C | 7 day | Rheology Results | |
| Comparative | Force | Failure | Peel Force | Failure | Adhesion | Tan Delta |
| Examples | (N/m) | Mode | (N/m) | Mode | Build % | @100 °C |
| CE1 | 496.1 | Clean | 1224.4 | Clean | 146.0 | 0.46 |
| CE2 | 397.6 | Clean | 917.3 | Clean | 130.4 | 0.30 |
| CE3 | 689.0 | Clean | 1519.7 | Cohesive | 120.6 | 0.56 |
| CE4 | 716.5 | Clean | 1488.2 | Cohesive | 107.2 | 0.67 |
| CE5 | 700.8 | Clean | 1519.7 | Cohesive | 117.6 | 0.30 |
| CE6 | 547.2 | Clean | 1137.8 | Clean | 108.4 | 0.30 |
| CE7 | 559.1 | Clean | 1070.9 | Clean | 91.4 | 0.27 |
| CE8 | 669.3 | Clean | 1287.4 | Cohesive | 92.1 | 0.30 |
| CE9 | 783.5 | Clean | 1437.0 | Cohesive | 83.7 | 0.30 |
| CE10 | 551.2 | Clean | 1090.5 | Residue | 97.5 | 0.25 |
| CE11 | 649.6 | Clean | 1212.6 | Residue | 86.8 | 0.26 |
| CE12 | 771.7 | Clean | 1425.2 | Cohesive | 84.7 | 0.40 |
| CE13 | 629.9 | Clean | 1452.8 | Clean | 131.2 | 0.25 |
| CE14 | 535.4 | Clean | 1582.7 | Residue | 195.0 | 0.21 |
| CE15 | 259.8 | Clean | 1732.3 | Cohesive | 571.8 | 0.28 |
| CE16 | 736.2 | Clean | 1417.3 | Cohesive | 92.7 | 0.32 |
| CE17 | 661.4 | Clean | 1610.2 | Cohesive | 143.5 | 0.29 |
| CE18 | 681.1 | Clean | 1649.6 | Cohesive | 142.3 | 0.36 |
| CE19 | 614.2 | Clean | 1220.5 | Cohesive | 98.2 | 0.31 |
| CE20 | 602.4 | Clean | 1106.3 | Cohesive | 83.1 | 0.35 |
| CE21 | 594.5 | Clean | 1015.7 | Cohesive | 71.2 | 0.36 |
| CE22 | 692.9 | Clean | 1220.5 | Cohesive | 75.9 | 0.38 |
| CE23 | 708.7 | Clean | 1259.8 | Cohesive | 77.4 | 0.38 |
| CE24 | 720.5 | Clean | 1315.0 | Cohesive | 82.8 | 0.42 |

TABLE 10
Comparative Example Peel Strength and Rheology
Results with different substrates

| | | | 7 days/ | | |
|---|---|---|---|---|---|
| | | | 65.5 °C | | |
| | 72 hr Peel | 72 hr | Peel | 7 day | Tan |
| Comparative | Adhesion | Failure | Adhesion | Failure | Delta |
| Example | (N/m) | Mode | (N/m) | Mode | @100 °C |
| CE25 | 897.6 | Clean | 1303.1 | Cohesive | 0.35 |

Thus, various embodiments of an adhesive film with clean removal after aging are disclosed. Other features and combinations of features within the scope of this disclosure may be readily apparent to one skilled in the art having the benefit of the FIGURES, descriptions, and claims.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range.

Th singular forms “a,” “an,” and “the” encompass embodiments having plural referents unless its context clearly dictates otherwise.

The term “or” is generally employed in its inclusive sense, for example, to mean “and/or” unless the context clearly dictates otherwise.

The phrases “at least one of,” “comprises at least one of,” and “one or more of” followed by a list refers to any one of the items in the list and any combination of two or more items in the list.

The words “preferred” and “preferably” refer to embodiments of the disclosure that may afford certain benefits, under certain circumstances. However, other embodiments May also be preferred, under the same or other circumstances. Furthermore, the recitation of one or more preferred embodiments does not imply that other embodiments are not useful and is not intended to exclude other embodiments from the scope of the disclosure.

1. A precursor composition for an adhesive comprising:
a (meth)acrylate copolymer is made by a copolymerization of a monomeric mixture comprising:
an acid functional polar monomer being ethylenically unsaturated; and
a non-acid functional polar monomer being ethylenically unsaturated,
wherein the acid functional polar monomer and the non-acid functional polar monomer comprise an amount up to 15 percent by weight based on a total weight of monomeric units in the monomeric mixture, wherein the sum of all monomers in the monomeric mixture equals 100 percent by weight; and
a terpene phenolic tackifier with an amount ranging from 5 to 60 parts wherein the copolymer is equal to 100 parts.

2. The precursor composition of claim 1, wherein the monomeric mixture further comprises a C1-C14 (meth)acrylic acid ester monomer.

3. The precursor composition of claim 2, wherein the C1-C14 (meth)acrylic acid ester monomer is selected from the group consisting of N-butyl (meth)acrylate, methyl (meth)acrylate, ethyl (meth)acrylate, hydroxyethyl (meth)acrylate, hydroxypropyl (meth)acrylate, tert-butyl acrylate, iso-butyl (meth)acrylate, iso-octyl (meth)acrylate, 2-ethylhexyl (meth)acrylate, 2-methylbutyl (meth)acrylate, isobornyl (meth)acrylate, 2-propylheptyl (meth)acrylate, cyclohexyl (meth)acrylate, benzyl (meth)acrylate, tetrahydrofurfuryl (meth)acrylate, and any mixtures thereof.

4. The precursor composition of claim 1, wherein the acid functional polar monomer is selected from the group consisting of acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropane sulfonic acid, vinyl phosphonic acid, and mixtures thereof.

5. The precursor composition of claim 1, wherein the non-acid functional polar monomer is selected from the group consisting of N-vinyl-2-pyrrolidone, 2-hydroxyethyl meth)acrylate, N-vinyl caprolactam, and mixtures thereof.

6. The precursor composition of claim 1, wherein the terpene phenolic tackifier has a softening point within a range of 125 °C to 135 °C.

7. The precursor composition of claim 1, wherein the acid functional polar monomer comprises acrylic acid and the non-acid functional polar monomer comprises N-vinyl pyrrolidone.

8. The precursor composition of claim 1, wherein when the precursor composition is cured and applied as an adhesive between a polymeric film and a metal or painted metal substrate for 24 hours at CTH, the peel force is greater than or equal to 550 N/m as measured by the Aged Peel Adhesion Test Method.

9. The precursor composition of claim 1, wherein when the precursor composition is cured and applied as an adhesive between a polymeric film and a metal or painted metal substrate for 7 days at 65.5 °C, the adhesive has a clean removal from a substrate.

10. An adhesive made by curing the precursor composition according to claim 1.

11. An adhesive film comprising the adhesive according to claim 10.

12. The adhesive film of claim 11, further comprising a release liner coupled to the adhesive film.

13. The adhesive film of claim 11, further comprising a graphic film layer having opposite first and second major sides, the first major side coupled to the adhesive film.

14. The adhesive film of claim 13, further comprising an overlaminate coupled to the second major side of the graphic film layer.

15. The adhesive film of claim 14, further comprising a hardcoat on the overlaminate film.
